(19) United States
(12) Patent Application Publication
(10) Pub. No.: US 2014/0315239 A1
(43) Pub. Date: Oct. 23, 2014

(54) Tool and Method for Validating Operational Performance of a Photoluminescence Based Analytical Instrument

(71) Applicants: Dmitri Boris Papkovsky, Blarney County Cork (IE); James Nial Hynes, Ovens (IE)

(72) Inventors: Dmitri Boris Papkovsky, Blarney County Cork (IE); James Nial Hynes, Ovens (IE)

(73) Assignee: Luxcel Biosciences Ltd., Cork (IE)

(21) Appl. No.: 14/238,982

(22) PCT Filed: Aug. 17, 2011
(86) PCT No.: PCT/EP2011/064182

§ 371 Date: Jun. 5, 2014

(51) Int. Cl. G01N 21/64

(52) U.S. Cl. CPC G01N 21/64; G01N 21/6486
USPC 435/29; 250/458.1; 250/459.1

(57) ABSTRACT

A reference vessel and a method of validating operational integrity of an analytical instrument using the reference vessel. The reference vessel has certain design features that render it particularly suited for interrogation by a specific analytical instrument, and is equipped with a surrogate probe that generates a perceptible signal of known value when interrogated by that instrument regardless of the actual value of the variable in communication with the surrogate probe.

### BACKGROUND

Photoluminescent sensors or probes are a widely employed method of measuring analyte concentration, typically oxygen, within an enclosed space such as a package or container. See, for example United States Published Patent Applications 2009/0029402, 2008/8242870, 2008/215254, 2008/199360, 2008/190172, 2008/148817, 2008/146460, 2008/117418, 2008/0051646, and 2006/0002822, and U.S. Pat. Nos. 7,569,395, 7,534,615, 7,368,153, 7,138,270, 6,689,438, 5,718,842, 4,810,655, and 4,476,870.

Briefly, analyte concentration within a package or container can be measured by placing an analyte sensitive photoluminescent probe within the package or container, allowing the probe to equilibrate within the package or container, exciting the probe with radiant energy, and measuring the extent to which radiant energy emitted by the excited probe is quenched by the presence of the target analyte. Such optical sensors are available from a number of suppliers, including Presence Precision Sensing, GmbH of Regensburg, Germany, Oxysense of Dallas, Tex., United States, and Luxcel Biosciences, Ltd of Cork, Ireland.

Such probes can be used to quantify a rate of oxygen uptake by biological and chemical samples, thereby serving as a biomarker of cell or organism viability. Also, many oxygen-dependent enzymatic and chemical reactions can be monitored via oxygen consumption, providing a means for evaluating the performance of various reactants, catalysts, enzymes, etc. and the effect of various conditions (e.g., temperature, pressure, concentrations, etc.).

The placement of photoluminescent probes into vials for monitoring oxygen consumption by a sample placed into the vial is known. U.S. Pat. Nos. 5,371,016 and 6,080,574 describe optical systems for measuring sample sterility and microbial growth by monitoring oxygen consumption by a sample placed within a vial having a fluorescence-based oxygen sensor built into the vial. W098/15645 describes an optical system that uses a solid-state luminescence-based oxygen sensor to assess a biological sample containing living micro-organisms by measuring gradients of dissolved oxygen within the sample. U.S. Pat. No. 5,882,922 describes a system for measuring oxygen consumption in samples using wells containing a solid-state oxygen sensor coating applied to the bottom of each well or soluble oxygen probes added to each sample.

The technique is well suited for use in establishing whether the microbial count in a product, such as a processed food, meets health and safety standards established for such products. When employed for such purposes, the system typically reports each sample as PASS/FAIL based upon whether the sample is found to have a microbial count above or below an established threshold value, with the vast majority of samples reported as PASS.

Unfortunately, such systems are susceptible to masked malfunctions (i.e., a gross malfunction—as opposed to a minor error in accuracy such as a drift in calibration—in an analytical instrument that causes the instrument to generate false data or provide false reports which are not readily noticed during normal use and operation of the instrument) as a system suffering from a gross malfunction is likely to report samples as PASS even though the system is not effectively measuring microbial count. When a masked malfunction is discovered it can require the destruction and/or recall of product manufactured over a substantial period of time as there is no way to ascertain when the masked malfunction occurred.

Accordingly, a substantial need exists for quick, simple and inexpensive tool and method for validating operational performance of photoluminescence based analytical instruments.

### SUMMARY OF THE INVENTION

A first aspect of the invention is a tool. The tool is specially adapted for use in combination with working vessels having a certain design feature and equipped with a working probe sensitive to a given variable of a sample placed within the working vessel so as to be capable of generating a perceptible signal reflective of the value of such sensed variable when interrogated by an instrument specifically adapted to interrogate a working probe on a working vessel.

A first embodiment of the first aspect of the invention comprises a reference vessel having the certain design feature and equipped with a surrogate probe effective for consistently generating a perceptible signal of known value when interrogated by the instrument regardless of the actual value of the variable in communication with the surrogate probe.

The first embodiment of the first aspect of the invention is preferably adapted for use in connection with an instrument that is effective for classifying a sample within a working vessel as a positive sample or a negative sample based upon a threshold value of the perceptible signal generated by the working probe on the working vessel containing the sample, and the known value of the perceptible signal generated by the surrogate probe on the reference vessel when interrogated by the instrument is effective for causing the reference vessel to be classified as a positive sample when interrogated by the instrument.

A second embodiment of the first aspect of the invention comprises a reference vessel having the certain design feature and equipped with a surrogate probe effective for consistently generating a perceptible signal indicative of a positive sample in communication with a working probe when interrogated by the instrument regardless of the actual value of the variable in communication with the surrogate probe.

A second aspect of the invention is also a tool. The tool is useful for detecting changes in a variable characteristic of samples so as to permit classification of each sample as a positive sample or a negative sample. The second aspect of the invention, includes at least (i) a plurality of working vessels, each equipped with a working probe sensitive to a given variable of a sample placed into the vessel and capable of generating a perceptible signal reflective of the value of such given variable, and (ii) at least one reference vessel equipped with a surrogate probe effective for consistently generating a perceptible signal indicative of a positive sample in communication with a working probe regardless of the actual value of the variable in communication with the probe.

A third aspect of the invention is a method for validating operational integrity of an analytical instrument. A first embodiment of the third aspect includes the steps of (i) identifying an analytical instrument specifically adapted to interrogate photoluminescent working probes on vessels having a particular design feature, (ii) obtaining a tool in accordance with the first embodiment of the first aspect of the invention wherein the certain design feature is the particular design feature, (iii) interrogating the surrogate probe on the reference vessel with the identified analytical instrument to generate a perceptible signal having a reference value, and, (iv) comparing the reference value with the known value.

A second embodiment of the third aspect includes the steps of (i) identifying an analytical instrument specifically adapted to interrogate photoluminescent working probes on vessels having a particular design feature, (ii) obtaining a tool in accordance with the second embodiment of the first aspect of the invention wherein the certain design feature is the particular design feature and the value of the perceptible signal generated by interrogation of the surrogate probe is known, (iii) interrogating the surrogate probe on the reference vessel with the identified analytical instrument to generate a perceptible signal having a reference value, and (iv) comparing the reference value with the known value.

A fourth aspect of the invention is also a method for validating operational integrity of an analytical instrument. The method includes the steps of (i) identifying an analytical instrument specifically adapted to interrogate photoluminescent working probes on vessels having a particular design feature, (ii) obtaining a tool in accordance with the second aspect of the invention wherein the certain design feature is the particular design feature and the value of the perceptible signal generated by interrogation of the surrogate probe is known, (iii) placing aliquots from one or more samples into a plurality of the working vessels to form filled working vessels, (iv) periodically interrogating the working probes on the filled working vessels with the identified analytical instrument throughout a testing period, (v) recording data obtained from interrogation of the filled working probes, (vi) interrogating the surrogate probe on the reference vessel at least once during the testing period with the identified analytical instrument to generate a perceptible signal having a reference value, (vii) comparing the reference value with the known value, and (viii) designating the recorded data as invalid when the reference value deviates from the known value by a threshold value.

A fifth aspect of the invention is a method for assessing any change in the value of a perceptible signal generated by a photoluminescent working probe sensitive to a given variable, caused by an attribute of a sample placed into operable communication with the probe other than the given variable. The fifth aspect of the invention includes the steps of (i) obtaining a tool in accordance with the first embodiment of the first aspect of the invention, (ii) interrogating the surrogate probe on the reference vessel sans sample to generate a perceptible signal having a reference value, (iii) placing an aliquot from a sample into the reference vessel to form a filled reference vessel, (iv) interrogating the surrogate probe on the filled reference vessel to generate a perceptible signal having an affected value, and (v) determining deviation between reference value and affected value.

The determined deviation can be employed to calibrate the analytical instrument used to interrogate the surrogate probe in order to compensate for the determined deviation.

### BRIEF DESCRIPTION OF THE DRAWINGS

FIG. 1 is a side view of one embodiment of a reference vessel in accordance with this invention.

FIG. 1A is a grossly enlarged cross-sectional side view of the surrogate probe depicted in FIG. 1.

FIG. 2 is a side view of one embodiment of a several working vessels in accordance with this invention, each containing a sample.

FIG. 2A is a grossly enlarged cross-sectional side view of the working probe depicted in FIG. 2.

FIG. 3 is a depiction of one of the working vessels depicted in FIG. 2 being interrogated by an analytical instrument adapted to interrogate the working probe on the working vessel.

### DETAILED DESCRIPTION OF A PREFERRED EMBODIMENT

### Nomenclature

10 Interrogation Device

15 Display Component of Interrogation Device

20r Reference Vessel

20w Working Vessel

21r Open Top End of Reference Vessel

21w Open Top End of Working Vessel

22r Closed Bottom End of Reference Vessel

22w Closed Bottom End of Working Vessel

29r Retention Chamber of Reference Vessel

29w Retention Chamber of Working Vessel

30r Surrogate Probe on Reference Vessel

30w Working Probe on Working Vessel

31r Oxygen-Sensitive Photoluminescent Dye Component of Surrogate Probe

31w Oxygen-Sensitive Photoluminescent Dye Component of Working Probe

32r Carrier Matrix Component of Surrogate Probe

32w Carrier Matrix Component of Working Probe

40 Barcode

50 Sample

### Definitions

As used herein, including the claims, the phrase “positive sample” means a sample that, when in operable communication with a probe/sensor sensitive to a given variable and within any appropriate test period during which pertinent changes in the given variable should occur in the sample, causes the probe to generate a perceptible signal indicating that the value of the given variable possessed or exhibited by the sample is beyond a detectable threshold value. For example, a sample in communication with an oxygen sensitive photoluminescent probe in which viable aerobic bacteria within the sample has consumed sufficient oxygen to reduce the dissolved oxygen concentration in the sample below a threshold value of 10% O₂ within twelve hours—detected by measuring changes in the probe's optical signal—is a positive sample.

As used herein, including the claims, the phrase “negative sample” means a sample that, when in operable communication with a probe sensitive to a given variable and after any appropriate test period during which pertinent changes in the given variable should occur in the sample, does not cause the probe to generate a perceptible signal indicating that the value of the given variable possessed or exhibited by the sample is beyond a detectable threshold value. For example, (i) a sample in communication with an oxygen sensitive photoluminescent probe in which viable aerobic bacteria within the sample have not consumed sufficient oxygen to reduce the dissolved oxygen concentration in the sample below 10% O₂ from the initial concentration within an appropriate test period of twelve hours—detected by measuring changes in the probe's optical signal—when the threshold value is at 10% O₂ from the initial concentration, is a negative sample, and (ii) a sample in communication with an oxygen sensitive photoluminescent probe in which viable aerobic bacteria within the sample required sixteen hours to consume sufficient oxygen to reduce the oxygen concentration in the sample to a threshold value of a 10% reduction from the initial concentration—detected by measuring changes in the probe's optical signal—when the appropriate test period is twelve hours, is a negative sample.

As used herein, including the claims, the phrase “oxygen permeable” means a material that when formed into a 1 mil (25.4 μm) film has an oxygen transmission rate of greater than 1,000 cm³/m² day when measured in accordance with ASTM D 3985.

As used herein, including the claims, the phrase “highly oxygen permeable”means a material that when formed into a 1 mil (25.4 μm) film has an oxygen transmission rate of greater than 2,000 cm³/m² day when measured in accordance with ASTM D 3985.

As used herein, including the claims, the phrase “oxygen impermeable” means a material that when formed into a 1 mil (25.4 μm) film has an oxygen transmission rate of less than 100 cm³/m² day when measured in accordance with ASTM F 1927.

As used herein, including the claims, the phrase “oxygen barrier” means a layer of material or laminated layers of materials that has an oxygen transmission rate of less than 200 cm³/m² day when measured in accordance with ASTM F 1927.

As used herein, including the claims, the phrase “masked malfunction”, when used to describe a condition of an analytical instrument, means a gross malfunction—as opposed to a minor error in accuracy such as a drift in calibration—in an analytical instrument that causes the instrument to generate false data or provide false reports which are not readily noticed during normal use and operation of the instrument. For example, complete failure of a sensor in an analytical instrument that causes the instrument to report all samples as NEGATIVE or ACCEPTABLE (e.g., containing less than a threshold concentration of a target-analyte) regardless of actual conditions, when all samples are normally and routinely reported as NEGATIVE or ACCEPTABLE, is a “masked malfunction”.

### Construction

A first aspect of the invention is a tool useful for validating operational integrity of an analytical instrument 10 designed to interrogate photoluminescent working probes 30w on working vessels 20w having a particular design feature. The particular design feature may be selected from any design feature or characteristic including specifically, but not exclusively size, shape, exterior contour, configuration, location of working probe 30w on the working vessel 20w, etc.

The working probe 30w can be any device capable of sensing and reporting changes in a given variable, such as changes in a target-analyte concentration (e.g., H⁺, CO, CO₂ or O₂), within an enclosed volume. In a preferred embodiment, the working probe 30w is an optically-active, target-analyte sensitive material configured and arranged to experience changes in target-analyte concentration or partial pressure P_{A} in a sample 50 placed within the retention chamber 29w of a working vessel 20w. The analyte-sensitive material is preferably a photoluminescent dye embedded within an analyte permeable polymer matrix. Since the preferred type of working probe 30w is an optically-active, target-analyte sensitive material, and the most frequent target-analyte of interest is oxygen, the balance of the disclosure shall be based upon a photoluminescent oxygen quenched working probe 30w without intending to be limited thereby.

Analytical instruments 10 for interrogating probes based on the quenching of photoluminescence by an analyte are well known and commercially available from various sources, including bioMérieux SA of France and Mocon, Inc. of Minneapolis, Minn.

The radiation emitted by an excited probe can be measured in terms of intensity and/or lifetime (rate of decay, phase shift or anisotropy), with measurement of lifetime generally preferred as a more accurate and reliable measurement technique.

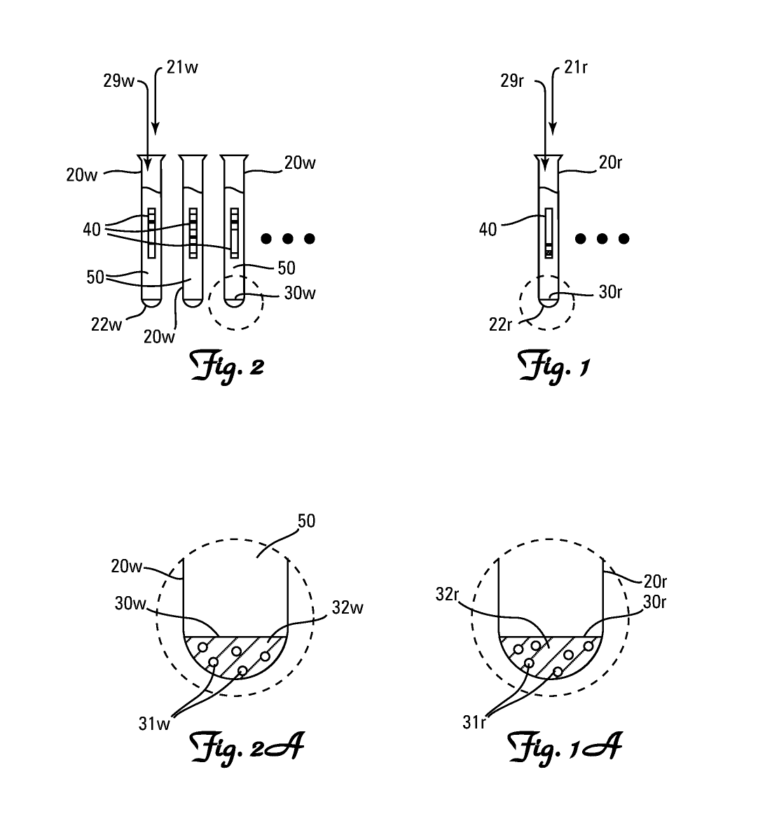

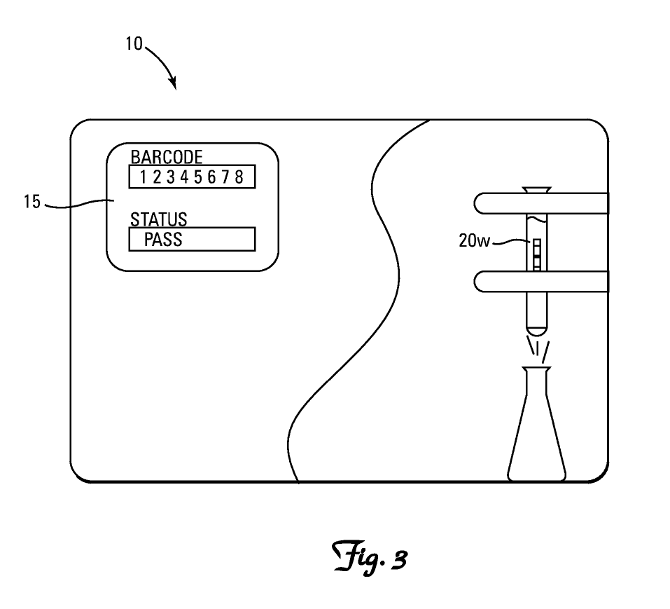

Referring to FIGS. 1 and 1A, the tool is a reference vessel 20r having the particular design feature and equipped with a surrogate probe 30r. Providing the reference vessel 20r with the particular design feature allows the reference vessel 20r to be interrogated by the analytical instrument 10 without requiring special handling or manipulation of the reference vessel 20r or irregular operation of the analytical instrument 10.

The surrogate probe 30r is effective for consistently generating a perceptible signal of known value when interrogated by the instrument 10 regardless of the actual value of the variable (e.g., oxygen concentration) in communication with the surrogate probe 30r. That known value is preferably one that is effective for causing the reference vessel 20r to be classified as a positive sample when interrogated by the instrument 10.

In a preferred embodiment, the surrogate probe 30r comprises an oxygen-sensitive photoluminescent dye 31r that is the same as the oxygen-sensitive photoluminescent dye 31w employed in working probes 30w interrogated by the analytical instrument 10, but contrary to the working probes 30w that embed the oxygen-sensitive photoluminescent dye 31w within a working carrier matrix 32w that render the working probe 30w sensitive to oxygen concentration, the surrogate probe 30r embeds the oxygen-sensitive photoluminescent dye 31r within a surrogate carrier matrix 32r that renders the surrogate probe 30r less sensitive to oxygen concentration. Most preferably the surrogate carrier matrix 32r is an oxygen impermeable material effective for causing the analytical instrument 10 to reliably recognize and report the surrogate vessel 20r as a vessel containing a positive sample 50 regardless of the actual concentration of oxygen in the retention chamber 29r of the reference vessel 20r.

The reference vessel 20r is preferably selected from the same stock used for the working vessels 20w. Exemplary vessels suitable for use as the working vessels 20w—and thereby the reference vessel 20r, include vials, cuvettes, multi-well plates (e.g., 6, 12, 24, 48, 96 and 384 well plates), and the like formed from materials such as a plastic (e.g., polypropylene or polyethylene terphthalate) or glass.

When the surrogate probe 30r is based on the quenching of photoluminescence by an analyte, the reference vessel 20r, or at least that portion of the reference vessel 20r coated with the surrogate probe 30r, must allow radiation at the excitation and emission wavelengths to be transmitted to and received from the surrogate probe 30r with minimal interference. The surrogate probe 30r is preferably positioned within the retention chamber 29r proximate the bottom end 22r of the reference vessel 20r.

The oxygen-sensitive photoluminescent dye 31r and 31w may be selected from any of the well-known oxygen sensitive photoluminescent dyes used in the construction of oxygen sensitive photoluminescent probes (not shown). A nonexhaustive list of such oxygen sensitive photoluminescent dyes 50 includes specifically, but not exclusively, ruthenium(II)-bipyridyl and ruthenium(II)-diphenylphenanothroline complexes, porphyrin-ketones such as platinum(II)-octaethylporphine-ketone, platinum(II)-porphyrin such as platinum(II)-tetrakis(pentafluorophenyl)porphine, palladium(II)-porphyrin such as palladium(II)-tetrakis(pentafluorophenyl)porphine, phosphorescent metallocomplexes of tetrabenzoporphyrins, chlorins, azaporphyrins, and long-decay luminescent complexes of iridium(III) or osmium(II).

The surrogate carrier matrix 32r is selected to be less permeable to oxygen than the working carrier matrix 32w, and is preferably an oxygen-impermeable composition that renders the surrogate probe 30r at least 10 times less sensitive to oxygen than working probes 30w, more preferably at least 50 times less sensitive to oxygen than the working probes 30w, and most preferably at least 100 times less sensitive to oxygen than the working probes 30w.

The surrogate probe 30r preferably generates a photoluminescence intensity signal that will be unfailingly recognized by the analytical instrument and reported as a positive sample. One of routine skill in the art is capable of selecting a suitable surrogate carrier matrix 32r. A nonexhaustive list of suitable polymers for use as the oxygen-impermeable surrogate carrier matrix 62 includes specifically, but not exclusively, polyvinylidine chloride copolymers such as polyvinylidine chloride-polyvinyl chloride and polyvinylidene chloride-acrylonitrile, polyvinyl chloride, polyvinyl alcohol, polyethylene vinyl alcohol and polymethylmethacrylate.

As is well known to those of routine skill in the art, suitable working carrier matrix 32w include polymers such as silicone, polystryrene, polycarbonate, polysulfone, etc.

The reference vessel 20r is preferably imprinted with both computer readable (e.g., barcode) and human perceptible indicia 40 that identifies the vessel as a reference vessel 20r—thereby allowing the microcontroller for the analytical instrument 10 and/or the human operator to recognize the “positive” reading obtained from the surrogate vessel 20r as the result of a validation test, and also recognize the lack of a “positive” reading obtained from the surrogate vessel 20r as indicative of a system failure or malfunction requiring further investigation and possible remedial action.

A reference vessel 20r can be sold individually, as a consumable component of each analytical instrument 10, and/or as a consumable component of each set or group of working vessels 20w (e.g., a reference vessel 20r provide with each set of 40, 80, 100 or more working vessels 20w ordered) obtained for use with a given analytical instrument.

### Manufacture

The reference vessel 20r can be conveniently manufactured by the same basic processes employed to manufacture working vessels 20w except that the working carrier matrix 32w is replaced with a surrogate carrier matrix 32r. Briefly, the process includes the steps of (A) preparing a coating cocktail (not shown) which contains the surrogate oxygen-sensitive photoluminescent dye 31r, such as Pt-octaethylporphine-ketone, and the surrogate oxygen-impermeable carrier matrix 32r, such as polyvinylidene chloride-acrylonitrile co-polymer, in an organic solvent (not shown) such as acetone, (B) depositing a small amount of the cocktail (not shown) into the bottom 22r of the retention chamber 29r of a vessel having the appropriate design feature, (C) and allowing the cocktail (not shown) to dry.

Generally, the concentration of the surrogate carrier matrix 32r in the organic solvent (not shown) should be in the range of 0.1 to 20% w/w, with the ratio of dye 31r to surrogate carrier matrix 32r in the range of 1:50 to 1:5,000 w/w.

### Use

The reference vessel 20r can be used to quickly and easily validate operational integrity of an analytical instrument 10.

In a first embodiment, the surrogate probe 30r on a reference vessel 20r is interrogating with the analytical instrument 10 to generate a perceptible signal having a reference value, and the reference value is compared with the known value. If the reference value deviates from the known value by more than a predetermined threshold value, a perceptible signal is generated indicating detection of a system error or malfunction—typically a masked malfunction—that requires further investigation and potential remedial action.

In a second embodiment, the method includes the steps of (i) forming filled working vessels by placing aliquots from one or more samples 50 into a plurality of the working vessels 20w, (ii) periodically interrogating the working probes 30w on the filled working vessels 20w with the analytical instrument 10 throughout a testing period, (iii) recording data obtained from such interrogations, (iv) interrogating the surrogate probe 30r on the reference vessel 20r at least once during the testing period with the analytical instrument 10 to generate a perceptible signal having a reference value, (v) comparing the reference value with the known value, and (vi) designating the recorded data as invalid when the reference value deviates from the known value by a threshold value.

The reference vessel 20r can also be used to quickly and easily assessing any change in the value of a perceptible signal generated by a working probe 30w sensitive to a given variable, caused by an attribute of a sample 50 placed into operable communication with the working probe 30w other than the given variable. The method includes the steps of (i) interrogating a surrogate probe 30r on a reference vessel 20r sans sample 50 to generate a perceptible signal having a reference value, (ii) placing a sample 50 into the reference vessel 20r to form a filled reference vessel 20r, (iii) interrogating the surrogate probe 30r on the filled reference vessel 20r to generate a perceptible signal having an affected value, and (iv) determining deviation between reference value and affected value. The determined deviation can be employed to calibrate the analytical instrument 10 used to interrogate the surrogate probe 30r in order to compensate for the determined deviation.

1. A tool for use in combination with working vessels having a certain design feature, wherein the working vessels are equipped with a working probe sensitive to a given variable of a sample placed within the vessel so as to be capable of generating a perceptible signal reflective of the value of such sensed variable when interrogated by an instrument specifically adapted to interrogate working probes on vessels having the certain design feature, the tool comprising a reference vessel separate and distinct from the working vessels while having the certain design feature of the working vessels, the reference vessel equipped with a surrogate probe effective for consistently generating a perceptible signal of known value when interrogated by the instrument regardless of the actual value of the variable in communication with the surrogate probe.

2. The tool of claim 1 wherein (i) the instrument is effective for classifying a sample within a working vessel as a positive sample or a negative sample based upon a threshold value of the perceptible signal generated by the working probe on the working vessel containing the sample, and (ii) the known value is effective for causing the reference vessel to be classified as a positive sample when interrogated by the instrument.

3. A tool for use in combination with working vessels having a certain design feature, wherein the working vessels are equipped with a working probe sensitive to a given variable of a sample placed into the vessel so as to be capable of generating a perceptible signal reflective of the value of such sensed variable widen interrogated by an instrument specifically adapted to interrogate working probes on vessels having the certain design feature, the tool comprising a reference vessel separate and distinct from the working vessels while having the certain design feature of the working vessels, the reference vessel equipped with a surrogate probe effective for consistently generating a perceptible signal indicative of a positive sample in communication with a working probe whoa interrogated by the instrument regardless of the actual value of the variable in communication with the surrogate probe.

4. A tool for use in detecting changes in a variable characteristic of samples so as to permit classification of each sample as a positive sample or a negative sample, the tool comprising:
(a) a plurality of working vessels, each equipped with a working probe sensitive to a given variable of a sample placed into the vessel and capable of generating a perceptible signal reflective of the value of such given variable, and
(b) at least one reference vessel equipped with a surrogate probe effective for consistently generating a perceptible signal indicative of a positive sample in communication with a working probe regardless of the actual value of the variable in communication with the probe, wherein the ratio of working vessels to reference vessels is greater than 1:1.

5. The tool of claim 1 wherein the reference vessel is a vial, cuvette or multiwell plate.

6. The tool of claim 1 wherein the certain design feature includes at least one of configuration, exterior contour, location of the working probe on the working vessels, and size.

7. (canceled)

8. (canceled)

9. (canceled)

10. The tool of claim 1 wherein the surrogate probe comprises a solid state composition comprising a target-analyte-sensitive photoluminescent dye embedded within a carrier matrix that is impermeable to target-analyte.

11. The tool of claim 4 wherein (i) the working probes comprise a first solid state composition comprising a target-analyte-sensitive photoluminescent dye embedded within a target-analyte-permeable carrier matrix, wherein the first composition has a first sensitivity to target-analyte, and (ii) the surrogate probe comprises a second solid state composition comprising a target-analyte-sensitive photoluminescent dye embedded within a carrier matrix that is different from the carrier matrix in the first composition, wherein the second composition has a second sensitivity to target-analyte that is different than the first sensitivity to target-analyte.

12. The tool of claim 11 wherein the target-analyte is oxygen and the working probes and the surrogate probe contain the same oxygen sensitive photoluminescent dye.

13. (canceled)

14. (canceled)

15. (canceled)

16. (canceled)

17. (canceled)

18. (canceled)

19. The tool of claim 1 wherein the given variable is partial pressure of a target-analyte.

20. (canceled)

21. (canceled)

22. The tool of claim 4 wherein the working vessels and the surrogate vessel, sans probe, are identical.

23. The tool of claim 4 wherein the tool includes at least 40 working vessels per each reference vessel and the carrier matrix in the working probes is highly oxygen permeable.

24. (canceled)

25. (canceled)

26. (canceled)

27. (canceled)

28. A method for validating operational integrity of an analytical instrument, comprising the steps of:
(a) identifying an analytical instrument specifically adapted to interrogate photoluminescent working probes on vessels having a particular design feature,
(b) obtaining a tool in accordance with claim 1 wherein the certain design feature is the particular design feature,
(c) interrogating the surrogate probe on the reference vessel with the identified analytical instrument to generate a perceptible signal having a reference value, and
(d) comparing the reference value with the known value.

29. A method for validating operational integrity of an analytical instrument, comprising the steps of:
(a) identifying an analytical instrument specifically adapted to interrogate photoluminescent working probes on vessels having a particular design feature,
(b) obtaining a tool in accordance with claim 3 wherein the certain design feature is the particular design feature and the value of the perceptible signal generated by interrogation of the surrogate probe is known,
(c) interrogating the surrogate probe on the reference vessel with the identified analytical instrument to generate a perceptible signal having a reference value, and
(d) comparing the reference value with the known value.

30. A method for validating operational integrity of an analytical instrument, comprising the steps of:
(a) identifying an analytical instrument specifically adapted to interrogate photoluminescent working probes on vessels having a particular design feature,
(b) obtaining a tool in accordance with claim 4 wherein the certain design feature is the particular design feature and the value of the perceptible signal generated by interrogation of the surrogate probe is known,
(c) placing aliquots from one or more samples into a plurality of the working vessels to form filled working vessels,
(d) periodically interrogating the working probes on the filled working vessels with the identified analytical instrument throughout a testing period,
(e) recording data obtained from interrogation of the filled working probes,
(f) interrogating the surrogate probe on the reference vessel at least once during the testing period with the identified analytical instrument to generate a perceptible signal having a reference value,
(g) comparing the reference value with the known value, and
(h) designating the recorded data as invalid when the reference value deviates from the known value by a threshold value.

31. A method for assessing any change in the value of a perceptible signal generated by a photoluminescent working probe sensitive to a given variable, caused by an attribute of a sample placed into operable communication with the probe other than the given variable, comprising the steps of:
(a) obtaining a tool in accordance with claim 1,
(b) interrogating the surrogate probe on the reference vessel sans sample to generate a perceptible signal having a reference value,
(c) placing an aliquot from a sample into the reference vessel to form a filled reference vessel,
(d) interrogating the surrogate probe on the filled reference vessel to generate a perceptible signal having an affected value, and
(e) determining deviation between reference value and affected value.

32. The method of claim 31 further comprising the step of calibrating the analytical instrument used to interrogate the surrogate probe to compensate for the determined deviation.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. The method of claim 30 wherein the filled working vessels are incubated during the time period the working probe on the filled working vessels are interrogated, whereby microorganisms growing in the sample in the fitted working vessels can effect a variation in composition by the metabolic consumption or generation of a component.

48. (canceled)

49. The method of claim 30 wherein the working vessels and the surrogate vessels, sans probe, are identical, and samples are placed into at least 10 working vessels.

50. (canceled)

51. (canceled)

52. (canceled)

53. (canceled)

54. (canceled)

55. The method of claim 28 wherein the method is effective for detecting a masked malfunction.
